(19) United States
(12) Patent Application Publication
(10) Pub. No.: US 2024/0296507 A1
(43) Pub. Date: Sep. 5, 2024

(54) EMISSIONS IMPACT METRICS

(71) Applicant: ServiceNow, Inc., Santa Clara, CA (US)

(72) Inventors: Max Qiwen Lei, Newcastle, WA (US); Suvarna Venkatesh Patil, Bothell, WA (US)

(21) Appl. No.: 18/116,729

(22) Filed: Mar. 2, 2023

(51) Int. Cl. G06Q 50/06

(52) U.S. Cl. CPC G06Q 50/06; G06Q 10/0639

(57) ABSTRACT

Energy usage data of devices is received. Relative utilization values associated with the devices for an entity are determined. A carbon footprint of the entity is calculated based on the energy usage data, the relative utilization values, and one or more emissions impact factors associated with one or more energy sources of the devices. An interactive user interface dashboard providing information regarding the carbon footprint is provided.

### BACKGROUND OF THE INVENTION

Computing devices including the data centers they are installed within can contribute to greenhouse gas emissions due to their reliance on electricity. The generated emissions are commonly measured by calculating a carbon footprint. An accurately calculated carbon footprint depends on both the amount of electricity used as well as the sources for the electricity relied upon. Respective carbon footprints for similar computing devices and/or data centers can differ vastly depending on their respective electricity sources even if they utilize similar amounts of electricity.

### BRIEF DESCRIPTION OF THE DRAWINGS

Various embodiments of the invention are disclosed in the following detailed description and the accompanying drawings.

FIG. 1 is a block diagram illustrating an example of a network environment for determining emissions metrics.

FIG. 2 is a block diagram illustrating an example of a device rack configured for determining emissions metrics.

FIG. 3 is a block diagram illustrating an example of a network environment configured with device usage agents for determining emissions metrics.

FIG. 4 is a flow chart illustrating an embodiment of a process for determining emissions metrics.

FIG. 5 is a flow chart illustrating an embodiment of a process for configuring devices and entities for determining emissions metrics.

FIG. 6 is a flow chart illustrating an embodiment of a process for determining emission input factors and metrics across devices and entities.

FIG. 7 is a flow chart illustrating an embodiment of a process for determining an emission impact factor for a particular device.

FIG. 8 is a flow chart illustrating an embodiment of a process for providing emissions metrics in response to an emissions metrics request.

FIG. 9 is a functional diagram illustrating a programmed computer system for determining emissions metrics.

FIG. 10 is a diagram illustrating an embodiment of a user interface for viewing emissions metrics for a data center via an emissions dashboard.

FIG. 11 is a diagram illustrating an embodiment of a user interface for viewing emissions metrics for an entity via an emissions dashboard.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for calculating greenhouse gas emissions and related metrics is disclosed. In various embodiments, a real-time data acquisition system gathers energy usage data, such as from data centers, on a per-device level of granularity. These computing devices are further monitored by discovery modules to determine the appropriate amount of CPU activity to attribute between different customers. Based on their relative device usages and the gathered device energy usage data, the observed energy usage is allocated between different customers. For example, within a data center and a set of computing devices installed within the data center, the amount of electricity utilized by each customer is determined. In various embodiments, for each contributing location, such as a data center location, the source of electricity for the location is evaluated to determine its impact factor on emissions. Using the determined customer energy usage data and the emissions impact factor of different energy sources, a real-time carbon footprint can be calculated for both customers (who may be spread across multiple data centers) and data centers (each of which may include multiple customers). The carbon footprint metrics are presented using an interactive user interface dashboard. For example, in various embodiments, a web-based dashboard presents the calculated carbon footprint metrics along with the ability to drill down to inspect metrics related to specific devices at specific locations for specific time frames as well as the ability to aggregate emissions metrics across locations, devices, and time frames.

In some embodiments, energy usage data of devices is received. For example, energy usage data of devices is monitored using one or more power monitoring devices. In some embodiments, the devices, such as network servers and other networking equipment, are plugged into power monitoring devices, which are configured to report the energy usage of any attached devices. For example, a server rack is configured with one or more power monitoring devices and each computing device installed in the server rack is powered via a power monitoring device. The energy usage data can be provided in real-time, such as continuously, over configured intervals, and/or using another appropriate configuration. The gathered energy usage data can be provided to and stored via a cloud service. In some embodiments, relative utilization values associated with the devices for an entity are determined. For example, each device can be monitored to determine the relative processor utilization values associated with different entities, such as different user accounts or customers. The different relative utilization values for each entity are determined and can be provided to and stored via a cloud service. In some embodiments, the monitoring is performed by one or more agents, such as discovery agents that can include an agent monitoring module component installed on each device. For example, an installed monitoring agent can provide the relative utilization values attributed to each entity utilizing a corresponding device. Similar to the energy usage data, the gathered entity utilization metrics can be provided to and stored via a cloud service.

In some embodiments, a carbon footprint of the entity is calculated based on the energy usage data, the relative entity utilization values, and one or more emissions impact factors associated with one or more energy sources of the devices. For example, using the energy usage data of a device, the utilization associated with an entity for a device, and an emissions impact factor for the device's power source, the carbon footprint for the entity utilizing the device is determined. Further, the carbon footprint for the entity can be determined for each device the entity is associated with and one or more aggregate sums can be determined for the data centers the entity utilizes as well as across all data centers an entity utilizes. In some embodiments, the entity can be a user account, a customer, a service provider, or another organizational structure. In various embodiments, an emission impact factor is a conversion factor that can be applied to convert energy usage into an emissions metric such as the amount of greenhouse gases generated for a given amount of energy. In various embodiments, the emissions impact factor will vary based on the power source. For example, different power sources will have different emission impact factors based on how each power source generates its electricity. In many scenarios, the location of an installed device directly impacts its power source and thus the location of the device correlates to its emission impact factor.

In some embodiments, an interactive user interface dashboard providing information regarding the carbon footprint is provided. For example, network clients can access a dashboard that displays the calculated emissions metrics along with different granularities of the emissions metrics calculations. In various embodiments, the provided dashboard allows the client, such as a network administrator, to drill down on the carbon footprint associated with an entity. For example, using the provided dashboard, an entity's aggregate carbon footprint across all data centers or devices can be shown as well as the carbon footprint associated with one or more selected data centers or locations of the installed devices. Moreover, in using the provided dashboards, different time frames of emission can be provided, such as daily, weekly, monthly, yearly, or another configured time frame. In some embodiments, an administrator can further drill down to show the carbon footprint of each entity device, such as each entity device within a data center or even each entity device installed on a particular rack within a data center. In some embodiments, the gathered metrics and/or factors used to calculate the carbon footprint metrics, such as energy usage, utilization values, and/or emissions impact factors, are also provided via the dashboard.

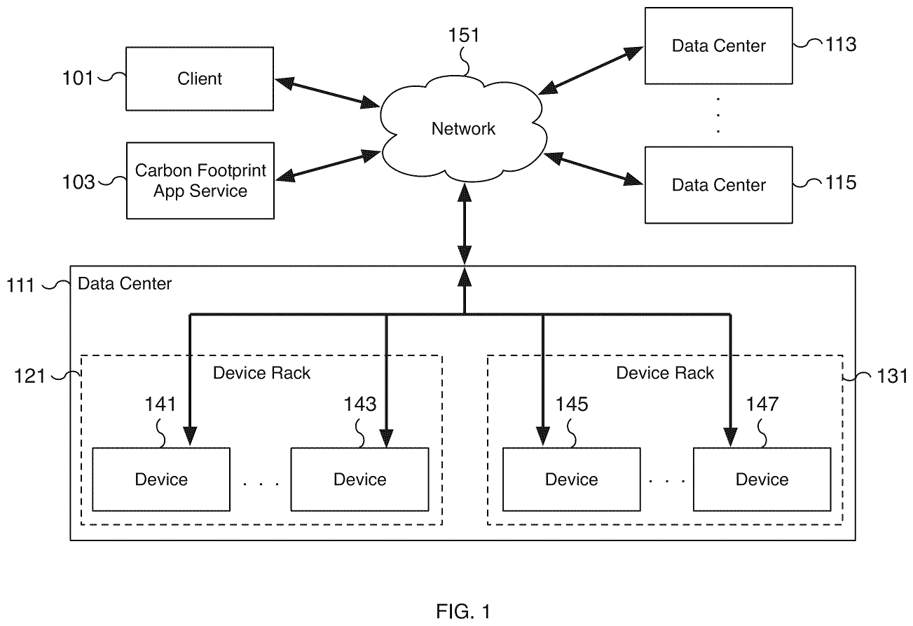

FIG. 1 is a block diagram illustrating an example of a network environment for determining emissions metrics. In the example shown, client 101 accesses emission metrics calculated and/or provided by carbon footprint app service 103 for entity devices associated with one or more of data centers 111, 113, and/or 115. Client 101, carbon footprint app service 103, and data centers 111, 113, and 115 are connected via network 151. Network 151 can be a public or private network. In some embodiments, network 151 is a public network such as the Internet. In various embodiments, carbon footprint app service 103 is a cloud-based application server that provides emissions metrics for devices associated with a particular entity. For example, devices are installed in a data center using one or more device racks such as device racks 121 and 131 of data center 111. In the example shown, example device racks include device rack 121 of data center 111 with devices 141 and 143 installed and device rack 131 of data center 111 with devices 145 and 147 installed.

In some embodiments, client 101 is a network client for accessing and/or managing cloud services of carbon footprint app service 103. For example, using a web browser client, client 101 can access web services hosted by carbon footprint app service 103 such as a dashboard for examining calculated carbon emissions for relevant devices associated with client 101. In some embodiments, client 101 corresponds to a specific user account, customer, service provider, and/or another organizational structure. In some embodiments, client 101 is a desktop computer, a laptop, a mobile device, a tablet, a kiosk, a voice assistant, a wearable device, or another network computing device.

In some embodiments, carbon footprint app service 103 provides cloud-based emissions metrics for one or more devices installed across one or more locations such as within one or more different data centers. Example data centers include data centers 111, 113, and 115 although other locations for devices are appropriate as well. In some embodiments, carbon footprint app service 103 utilizes one or more discovery agents (not shown) that can include an agent monitoring module component installed on each relevant device to monitor utilization. Moreover, carbon footprint app service 103 can determine energy usage data for the relevant devices along with emissions impact factors associated with the energy sources utilized by the relevant devices. After calculating carbon footprint metrics for an entity, carbon footprint app service 103 provides the metrics via a dashboard such as via an interactive user interface dashboard to client 101. In various embodiments, carbon footprint app service 103 stores collected data and emissions metrics in a cloud-based data store (not shown).

In some embodiments, computing devices including network servers, network equipment, and other devices, are installed in one or more locations such as data centers 111, 113, and 115. Data center 111 is one example of a data center and includes devices 141, 143, 145, and 147 installed in their respective device racks. For example, devices 141 and 143 are installed in device rack 121 and devices 145 and 147 are installed in device rack 131. Although not shown in FIG. 1, device racks can be equipped with power monitoring devices to monitor and report the respective energy usage of installed devices. In various embodiments, the monitored power usage is provided to carbon footprint app service 103 to help determine the carbon footprint for associated devices.

Although single instances of some components have been shown to simplify the diagram of FIG. 1, additional instances of any of the components shown in FIG. 1 may exist. For example, carbon footprint app service 103 may include one or more servers. In various embodiments, data centers 111, 113, and/or 115 can include additional (or fewer) device racks and additional (or fewer) devices. In some embodiments, components not shown in FIG. 1 may also exist. For example, a cloud-based data store utilized by carbon footprint app service 103 is not shown. As another example, discovery agents and/or power monitoring devices used to monitor utilization and/or energy usage, respectively, for devices may exist but are not shown.

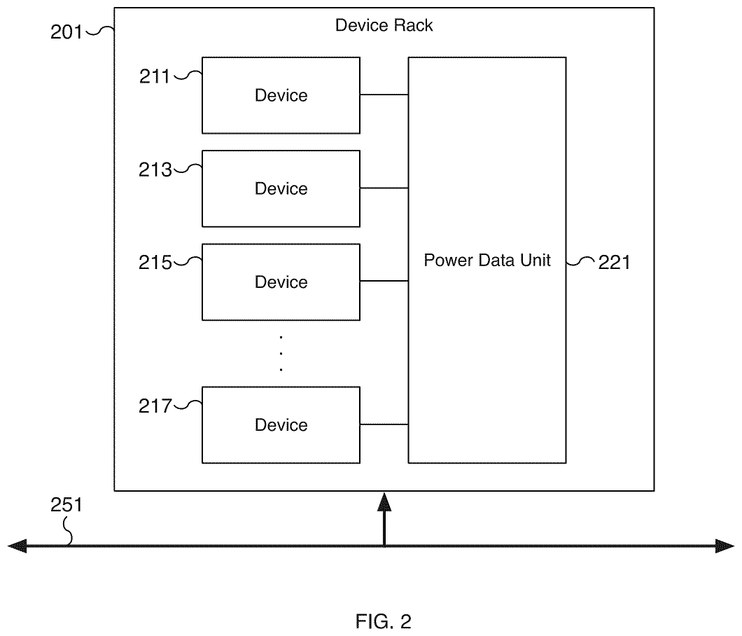

FIG. 2 is a block diagram illustrating an example of a device rack configured for determining emissions metrics. In the example shown, device rack 201 includes devices 211, 213, 215, and 217 and power data unit 221. Device rack 201 and the devices installed in device rack 201 are communicatively connected to network 251. In various embodiments, network 251 is a local network of a data center and may be connected to a public network such as the Internet. In some embodiments, device rack 201 is device rack 121 and/or 131 of FIG. 1 and network 251 is connected to network 151 of FIG. 1. In some embodiments, device rack 201 is located within a data center such as data center 111, 113, and/or 115 of FIG. 1. In some embodiments, device rack 201 along with devices 211, 213, 215, and/or 217 and power data unit 221 are configured for determining emissions metrics using a carbon footprint app service such as carbon footprint app service 103 of FIG. 1.

In some embodiments, device rack 201 is a device rack with installed devices 211, 213, 215, and 217. Devices 211, 213, 215, and 217 are networked computing devices and can include network servers, database servers, and additional network equipment such as network switches, firewalls, gateways, load balancers, etc., as well as other networked computing devices. In the example shown, devices 211, 213, 215, and 217 are powered through power data unit 221. In various embodiments, power data unit 221 is a power monitoring device that provides electricity and monitors energy usage of its connected devices. For example, power data unit 221 can monitor the energy usage of devices 211, 213, 215 and 217. In some embodiments, power data unit 221 can monitor the energy usage of connected devices continuously and/or within a certain time window such as every minute or another configured time window. In various embodiments, power data unit 221 provides the energy monitoring data to a cloud service such as carbon footprint app service 103 of FIG. 1 for determining carbon emissions of devices 211, 213, 215, and/or 217. For example, energy monitoring data can be provided via network 251 to a cloud-based emissions application service.

Although only a single power data unit is shown in FIG. 2, in some embodiments, device rack 201 is configured with multiple power data units. For example, each installed power data unit can be associated with at least one rack installed in a data center. Similarly, although four devices are shown installed in device rack 201, device rack 201 can include additional (or fewer) devices. In various embodiments, device rack 201 is an example embodiment of a device rack installed in a data center. In various embodiments, each device rack, such as device rack 201, is communicatively connected to a local data center network. Although only a single network, network 251, is shown for device rack 201, in some embodiments, device rack 201 includes multiple network connections.

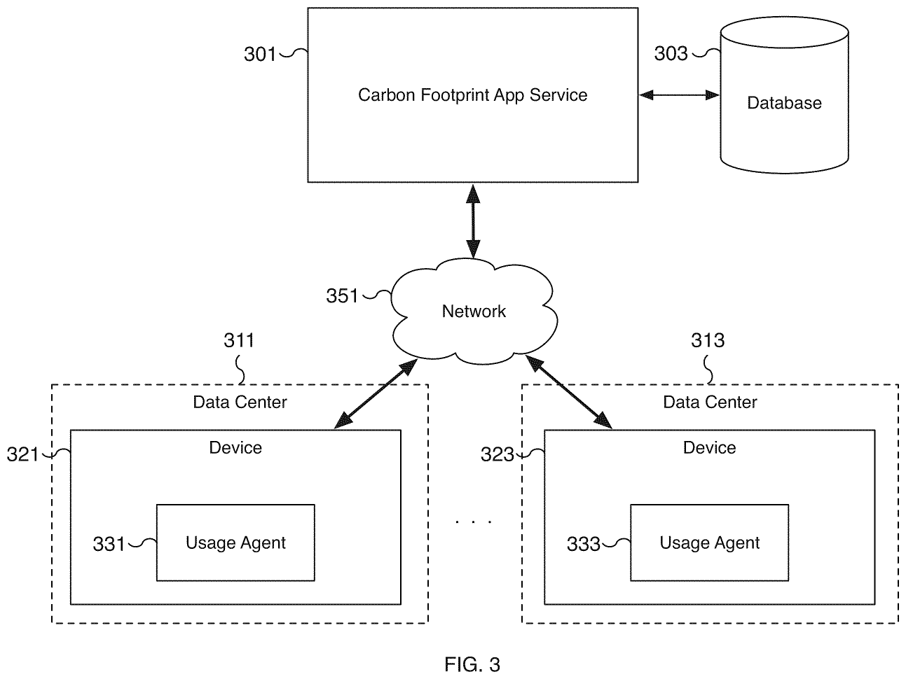

FIG. 3 is a block diagram illustrating an example of a network environment configured with device usage agents for determining emissions metrics. In the example shown, carbon footprint app service 301 utilizes cloud-based database 303 for calculating emissions metrics for devices 321 and 323 installed in data centers 311 and 313, respectively. Devices 321 and 323 are configured with usage agents 331 and 333, respectively, to monitor usage utilization. For example, in various embodiments, usage agents 331 and 333 provide usage utilization data to carbon footprint app service 301 for storing at cloud-based database 303. Carbon footprint app service 301, database 303, device 321, and device 323 are connected via network 351. Network 351 can be a public or private network. In some embodiments, network 351 is a public network such as the Internet. In some embodiments, carbon footprint app service 301 is carbon footprint app service 103 of FIG. 1, data center 311 and data center 313 are each one of data centers 111, 113, and 115 of FIG. 1, devices 321 and 323 are devices located within one of data centers 111, 113, and 115 of FIG. 1, and network 351 is network 151 of FIG. 1.

In various embodiments, carbon footprint app service 301 is a cloud-based application server that provides emissions metrics for devices associated with a particular entity, such as a particular user account, customer, service provider, or another organizational structure. The calculated emissions metrics can be based on entity utilization as observed by usage agents 331 and 333 installed on devices 321 and 323, respectively. For example, devices 321 and 323 installed in data centers 311 and 313, respectively, are monitored for utilization using usage agents 331 and 333, respectively. In various embodiments, usage agents 331 and 333 may be part of a larger discovery service that monitors the utilization of their multiple installed devices. For example, usage agents 331 and 333 can monitor the CPU utilization attributable to a particular entity on devices 321 and 323, respectively. In various embodiments, the monitored utilization data is provided to carbon footprint app service 301 where carbon footprint app service 301 stores the utilization data at database 303 and utilizes the data to calculate emissions metrics. Although not shown, in some embodiments, devices 321 and 323 are each installed in their respective device racks and are each configured using a power management device for monitoring and measuring energy usage, another input factor used to calculate emissions metrics.

In some embodiments, an internal server (not shown) is used to gather utilization data as part of a discovery service. For example, an internal server can be located within a customer's network infrastructure and behind a customer firewall to manage and gather utilization data in a more secure manner. In various embodiments, an internal server can be utilized to allow access to internal devices located within the customer network without exposing the devices and certain network connections to an external network.

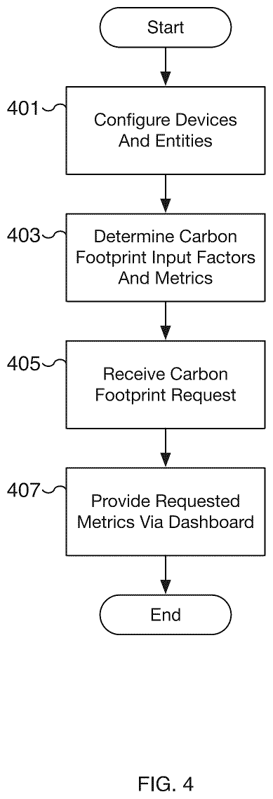

FIG. 4 is a flow chart illustrating an embodiment of a process for determining emissions metrics. For example, using the process of FIG. 4, a carbon footprint application service can calculate emissions metrics and provide the calculated metrics via a dashboard such as a web-based graphical user interface. In some embodiments, the process of FIG. 4 is performed using a cloud-based carbon footprint application service such as carbon footprint app service 103 of FIG. 1 and/or carbon footprint app service 301 of FIG. 3 on devices such as the devices of FIGS. 1, 2 and/or 3. In various embodiments, the devices are located at one or more locations such as within one or more different data centers.

At 401, devices and entities are configured. For example, one or more devices located at one or more different locations, such as at one or more different data centers, are configured for monitoring to determine their respective carbon footprints and/or emissions metrics. Along with the different configured devices, one or more different entities can be configured for which their respective carbon footprint and/or emissions metrics are calculated. In some embodiments, each entity corresponds to a different user account, customer, service provider, or another organizational structure. For example, different customer entities can be configured to track their respective carbon footprints across their configured devices, which may include overlapping (and potentially shared) devices.

At 403, carbon footprint input factors and metrics are determined. For example, using the devices and entities configured at 401, carbon footprint input factors and metrics are determined for one or more different time frames. In some embodiments, the metrics are calculated at least in part by determining the energy usage attributable to the configured devices and entities and the impact the energy utilized has on emissions. For example, one or more emissions impact factors can be determined for each energy source utilized by each device and/or entity. The determined emissions impact factors can then be used to determine the corresponding carbon footprint metrics. In some embodiments, the different input factors and their data sets are gathered and stored over time and the actual emissions metrics can be calculated using the various tracked input factors once a carbon footprint request is received.

At 405, a carbon footprint request is received. For example, a carbon footprint request for a set of devices and/or an entity is received. The request may specify one or more devices, one or more device locations (such as one or more data centers), and/or a particular entity (or entities) whose usage is associated with the devices. In some embodiments, the request also specifies a time frame, such as a daily, weekly, monthly, yearly, or another time-based window for which to provide emissions metrics. In some embodiments, the request is provided by a network client as part of interfacing with an emissions dashboard.

At 407, the requested carbon footprint metrics are provided via a dashboard. For example, based on the request received at 405, the requested carbon footprint metrics are calculated and provided via a dashboard. In some embodiments, the dashboard is a web-based graphical user interface and allows the client to submit subsequent requests that zoom out or drill-down on the data. For example, drilling down on the data allows the client to request more detailed metrics associated with a more refined set of devices, locations, and/or entities. In some embodiments, the dashboard also allows the user to provide a different time frame as well as the ability to aggregate results over different factors such as locations, devices, and entities. For example, daily, weekly, and monthly emissions information including carbon footprint calculations can be provided for one or more devices associated with an entity. In some embodiments, the information provided regarding carbon footprint calculations includes quantities of the carbon footprint of the entity associated with different physical locations and/or different devices. In various embodiments, the provided metrics can be determined in real-time based on carbon footprint input factors gathered at 403.

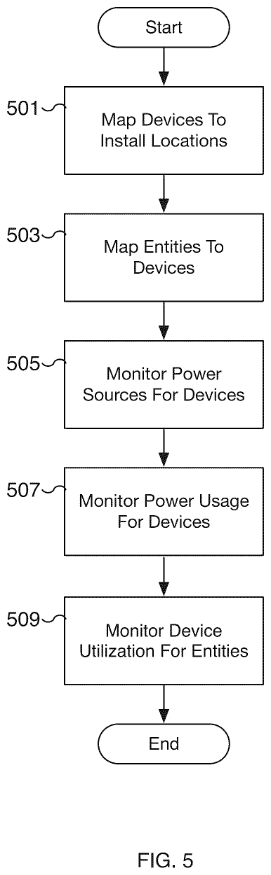

FIG. 5 is a flow chart illustrating an embodiment of a process for configuring devices and entities for determining emissions metrics. For example, using the process of FIG. 5, devices and entities can be configured for monitoring emissions factors. In some embodiments, the process is performed using a network client by accessing a cloud-based carbon footprint application service. In some embodiments, the process of FIG. 5 is performed by a cloud-based carbon footprint application service and corresponding monitoring devices, such as devices to monitor utilization and energy usage. In some embodiments, the cloud-based carbon footprint application service is carbon footprint app service 103 of FIG. 1 and/or carbon footprint app service 301 of FIG. 3 and the devices monitored include one or more of the devices of FIGS. 1, 2 and/or 3. In some embodiments, the process of FIG. 5 is performed at 401 of FIG. 4. In various embodiments, the monitored devices are located at one or more locations such as within one or more different data centers.

At 501, the devices are mapped to install locations. For example, all devices that are monitored for calculating emissions metrics are mapped to an install location. In some embodiments, the location is a physical location and includes an address. In various embodiments, the location can include the location of a data center a device is installed within. Moreover, the location can include the specific device rack and location within a rack that a device is installed. For example, a device's location can include a unique location within a data center and a corresponding input location into a power monitoring device such as a power data unit for powering the device and monitoring the device's usage over time. Once devices are mapped to install locations, a device's location can be readily identified. In various embodiments, the power source for the device is dependent on its install location. For example, a device's power source can be identified using its location.

At 503, the entities are mapped to devices. For example, each device mapped at 501 is further mapped at 503 to one or more entities. In some embodiments, the entities correspond to the users or user accounts running processes on a device. For example, a shared computing service running on a device may share resources across multiple entities. In some embodiments, the entity is a cloud service provider that itself can allocate resources among its customers, for example, as a reseller of cloud-based services. In various embodiments, an entity can correspond to a user account, a customer, a service provider (such as a cloud service provider), or another organizational structure and can be used to allocate device resources such as device computational resources. Once entities are mapped to devices, all the devices corresponding to an entity can be readily identified along with their corresponding locations.

At 505, power sources for devices are monitored. For example, the power sources utilized by devices are monitored. In some embodiments, the power source utilized is based on the location of a device and depending on the power source, the energy used by the device contributes differently to greenhouse emissions. At 505, the power sources are monitored at least in part to determine how much impact each power source has on emission metrics. In some embodiments, the impact on emissions by a power source can be expressed as an emissions impact factor. In various embodiments, the power sources for devices are gathered and provided to the cloud-based carbon footprint application service where the data is used as an input factor for determining emissions metrics. For example, for each device, a power source profile can be created that specifies the sources of power and/or electricity for a device.

At 507, power usage for devices is monitored. For example, using a power monitoring device, the power usage of each device is monitored. In some embodiments, the power monitoring device is a power data unit that is used to power a corresponding device and monitor its energy usage. In various embodiments, the energy usage for devices is monitored and the data is collected and provided to the cloud-based carbon footprint application service where the data is used as an input factor for determining emissions metrics.

At 509, device utilization for entities is monitored. For example, each entity's contribution to device utilization is monitored. In some embodiments, the utilization corresponds to CPU utilization and/or processor activity and is monitored using one or more agents such as a usage agent associated with a device. In some embodiments, a discovery service is utilized to track the utilization or processor activity attributable to different entities. For example, the CPU activity of a shared network server can be utilized by a first entity 80% of the time and by a second entity 20% of the time. The different utilization metrics are monitored and provided for calculating the respective impact on emissions metrics for each entity. In the previous scenario, for the particular device, the first entity contributes more to greenhouse emissions than the second entity. In various embodiments, the device utilization for entities is monitored and the data is collected and provided to the cloud-based carbon footprint application service where the data is used as an input factor for determining emissions metrics.

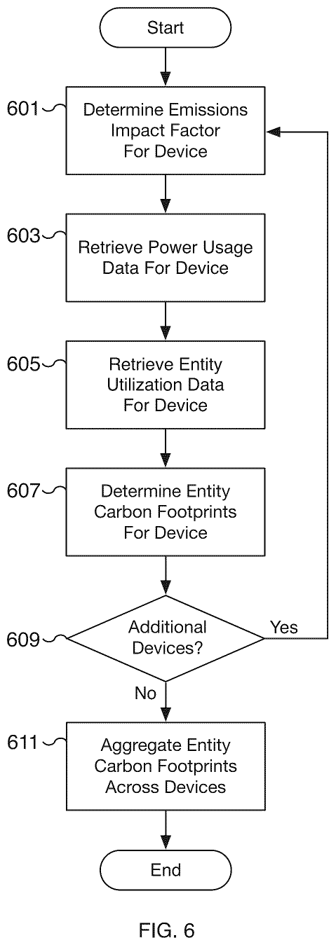

FIG. 6 is a flow chart illustrating an embodiment of a process for determining emission input factors and metrics across devices and entities. For example, using the process of FIG. 6, emissions factors and metrics are determined for different devices and the entities utilizing the corresponding devices. In some embodiments, the process of FIG. 6 is performed by a cloud-based carbon footprint application service and corresponding monitoring devices, such as devices to monitor utilization and energy usage. For example, the carbon footprint can be determined for each device and then emissions metrics can be aggregated across multiple devices associated with the entity. In some embodiments, the cloud-based carbon footprint application service is carbon footprint app service 103 of FIG. 1 and/or carbon footprint app service 301 of FIG. 3 and the devices monitored include one or more of the devices of FIGS. 1, 2 and/or 3. In some embodiments, the devices and/or entities are monitored using power monitoring devices such as power data unit 221 of FIG. 2 and/or usage agents 331 and/or 333 of FIG. 3. In some embodiments, the process of FIG. 6 is performed at 403 of FIG. 4 and/or at 505, 507, and/or 509 of FIG. 5. In various embodiments, the monitored devices are located at one or more locations such as within one or more different data centers.

At 601, an emissions impact factor is determined for a device. For example, using the device's configuration, an emissions impact factor is determined. The emissions impact factor is typically based on the power source of the device and the contribution the power source has to greenhouse emissions. For example, a device relying primarily on solar and hydro power may have a different emissions impact factor than a device relying on fossil fuels. In some embodiments, the emissions impact factor is based on the installed location of the device. For example, the installed location of the device can dictate the power source utilized by the device.

At 603, power usage data is retrieved for a device. For example, energy utilization data is retrieved for the particular device. In some embodiments, the power usage data for each device is collected by a power monitoring device such as a power data unit configured for that device and multiple power data units can be utilized to collect power usage data across multiple devices. The energy utilization can be tracked over a window of time allowing for very precise greenhouse emissions calculations. In some embodiments, the data is retrieved from a cloud-based datastore.

At 605, entity utilization data is retrieved for a device. For example, entity utilization data is retrieved for the particular device. In some embodiments, the entity utilization data is collected by one or more monitoring agents/devices and allows the energy utilized by the device to be attributed to different entities based on their respective device usage. The entity utilization can be tracked over a window of time allowing for very precise greenhouse emissions calculations. In some embodiments, the data is retrieved from a cloud-based datastore.

At 607, the entity carbon footprints are determined for a device. Using the emissions impact factor determined for a device at 601 and the different data retrieved at 603 and 605, a carbon footprint can be determined for the device and for each entity utilizing the device. In some embodiments, the total carbon footprint determined for a device is the sum of the different entity carbon footprints determined for the device. In some embodiments, the carbon footprint calculation is based on the amount of energy utilized multiplied by the emissions impact factor for a particular time period and/or for a particular entity. For example, a carbon footprint determination can be based on the activity attributable to an entity for a device multiplied by the energy consumption for the device multiplied by the carbon ratio for the power source of the device.

At 609, a determination is made whether additional devices exist for processing. In the event additional devices exist for processing, processing loops back to 601 where the next device is processed. In the event no additional devices exist for processing, processing continues to 611 where the entity carbon footprints can be aggregated across devices.

At 611, entity carbon footprints are aggregated across devices. For example, in some embodiments, for each entity, the entity carbon footprints can be aggregated across all devices associated with a particular entity. By adding together the different calculated device-specific entity carbon footprints, a total carbon footprint for an entity can be determined. In some embodiments, the aggregation is done for a particular location, such as a particular data center, or using another location filter such as a configured set of data centers or for all data centers associated with an entity. In various embodiments, the aggregation step can be optional and/or performed in real-time or on demand such as when the particular aggregation information is requested via an emissions dashboard.

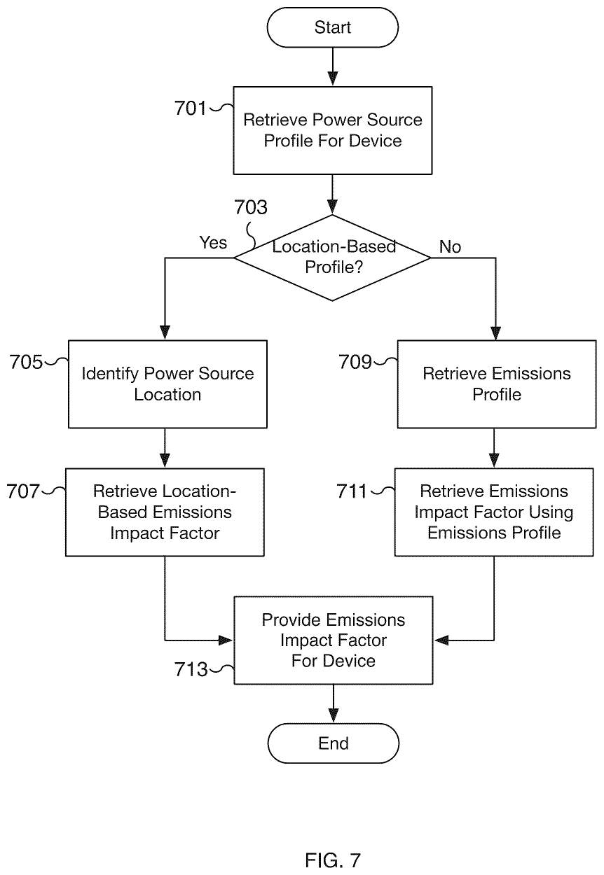

FIG. 7 is a flow chart illustrating an embodiment of a process for determining an emission impact factor for a particular device. For example, using the process of FIG. 7, an emissions impact factor is determined for a device that helps quantify the impact that the device's power source and energy utilization have on greenhouse emissions. In some embodiments, the emissions impact factor is based on the installed location of the device. However, in some scenarios, the location of the device can utilize an alternative power source than what is typically used for the device's location and the emission impact factor can be customized for that device. For example, a data center can be powered by an alternative energy source such as solar panels. In some embodiments, the process of FIG. 7 is performed by a cloud-based carbon footprint application service such as carbon footprint app service 103 of FIG. 1 and/or carbon footprint app service 301 of FIG. 3 on devices such as one or more of the devices of FIGS. 1, 2 and/or 3. In some embodiments, the process of FIG. 7 is performed at 403 of FIG. 4 and/or at 601 of FIG. 6.

At 701, the power source profile for a device is retrieved. For example, a power source profile is retrieved by a carbon footprint app service that describes the power source for a device. In some embodiments, the profile is stored in a cloud-based datastore such as database 303 of FIG. 3.

At 703, a determination is made whether the retrieved profile is a location-based profile. In the event the retrieved profile is a location-based profile, processing proceeds to 705. In the event the retrieved profile is not a location-based profile, processing proceeds to 709.

At 705, the power source location is identified. For example, the physical location of the power source is identified. In some embodiments, the physical location corresponds to an address including a city and/or county. In some embodiments, the location is a set of GPS location coordinates.

At 707, a location-based emissions impact factor is retrieved. For example, using the location information identified at 705, an emissions impact factor is retrieved. In some embodiments, the power source is determined based on the identified location and an emissions impact factor corresponding to the power source is retrieved. In various embodiments, devices at a particular location are typically configured with the same power source with a corresponding emissions impact factor based on the variety of power sources utilized by the locality. In such situations, the location information can be used to accurately resolve the power source used by the device.

At 709, an emission profile is retrieved. For example, a profile of the emissions associated with the power source are retrieved. In some embodiments, the power source profile retrieved at 701 is used to retrieve a corresponding emissions profile. The emissions profile may specify the breakdown of different power sources utilized by the device, such as a certain percentage of solar, hydro, wind, natural gas, and/or other power sources. In various embodiments, the emissions profile specifies the variety of power sources utilized by the device and can include different sources based on the time of day or other factors.

At 711, an emissions impact factor using the emissions profile is retrieved. Using the emissions profile retrieved at 709, an emissions impact factor is retrieved. In various embodiments, the emissions impact factor takes into account the different power sources utilized by the device and their contribution to greenhouse gases and/or carbon footprint.

At 713, the emissions impact factor for the device is provided. For example, the retrieved emission impact factor is provided for use in calculating the device's emissions metrics. In some embodiments, multiple emissions impact factors may be provided and the different factors may be applied based on the time of day or other factors such as season, weather, and availability. In various embodiments, the provided emissions impact factor can be stored by the cloud-based carbon footprint application service in a cloud-based data store such as database 303 of FIG. 3.

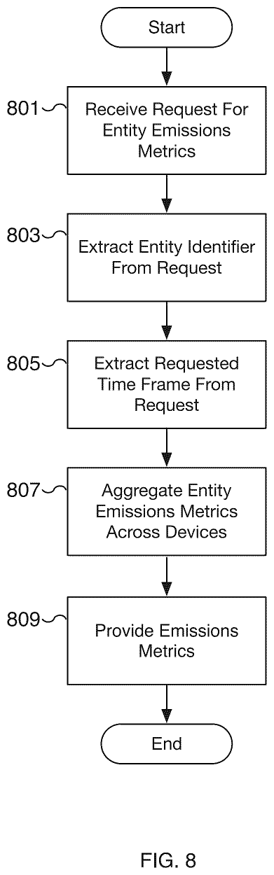

FIG. 8 is a flow chart illustrating an embodiment of a process for providing emissions metrics in response to an emissions metrics request. For example, using the process of FIG. 8, a carbon footprint application service can provide emissions metrics for a particular entity and/or devices via a dashboard. In some embodiments, the metrics are determined for devices spread across multiple different locations such as different data centers. In some embodiments, the process of FIG. 8 is performed by a cloud-based carbon footprint application service such as carbon footprint app service 103 of FIG. 1 and/or carbon footprint app service 301 of FIG. 3 for devices such as one or more of the devices of FIGS. 1, 2 and/or 3. In some embodiments, the process of FIG. 8 is performed at 405 and/or 407 of FIG. 4.

At 801, a request for entity emissions metrics is received. For example, a request is provided by a client such as a network client for emissions metrics. In some embodiments, the request is provided via a dashboard for interacting with emissions reports including reports on impact on carbon emissions. The request may specify the devices, locations, and/or corresponding entity and time frame for which to provide emissions metrics.

At 803, an entity identifier is extracted from the emissions request. For example, a unique identifier specifying a particular entity is extracted from the emissions request. In various embodiments, the entity identifier uniquely identifies an entity for which emissions metrics should be provided. In some embodiments, the entity identifier corresponds to a user account, a customer, a service provider, or another organizational structure.

At 805, the requested time frame is extracted from the emissions request. For example, a time frame such as over a particular day, week, month, or another time window is specified by and extracted from the emissions request. In various embodiments, different emissions metrics are possible depending on the requested time frame.

At 807, entity emissions metrics are aggregated across devices. For example, emissions metrics are calculated for an entity associated with a particular device and then aggregated to sum all the calculated emissions metrics for each requested device associated with the entity. In some embodiments, the aggregation is performed based on location, such as all the devices for an entity installed in a particular data center. Other forms of aggregation are appropriate as well, such as by geography, emissions footprint, or other filter parameters.

At 809, emissions metrics are provided. For example, using the metrics aggregated at 807, the calculated emissions metrics are provided. In some embodiments, the emission metrics are provided via a dashboard such as a graphical user interface to a network client via a web browser. In various embodiments, the provided metrics are interactive and the client can subsequently request additional emissions metrics such as for a different set of devices, locations, time frames, and/or entities, etc.

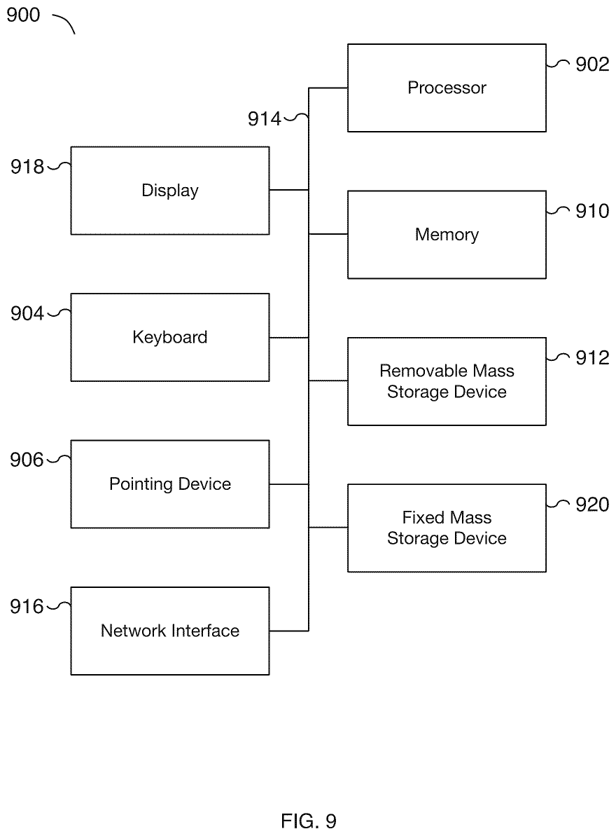

FIG. 9 is a functional diagram illustrating a programmed computer system for determining emissions metrics. As will be apparent, other computer system architectures and configurations can be utilized for order-preserving obfuscation of a protected dataset and/or performing comparison queries on the obfuscated data. Examples of computer system 900 include client 101 of FIG. 1, one or more computers of carbon footprint app service 103 of FIG. 1 and/or carbon footprint app service 301 of FIG. 3, one or more computers of database 303 of FIG. 3, and the devices of FIGS. 1, 2, and 3. Computer system 900, which includes various subsystems as described below, includes at least one microprocessor subsystem (also referred to as a processor or a central processing unit (CPU)) 902. For example, processor 902 can be implemented by a single-chip processor or by multiple processors. In some embodiments, processor 902 is a general purpose digital processor that controls the operation of the computer system 900. Using instructions retrieved from memory 910, the processor 902 controls the reception and manipulation of input data, and the output and display of data on output devices (e.g., display 918). In various embodiments, one or more instances of computer system 900 can be used to implement at least portions of the processes of FIGS. 4-8.

Processor 902 is coupled bi-directionally with memory 910, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 902. Also as is well known in the art, primary storage typically includes basic operating instructions, program code, data and objects used by the processor 902 to perform its functions (e.g., programmed instructions). For example, memory 910 can include any suitable computer-readable storage media, described below, depending on whether, for example, data access needs to be bi-directional or unidirectional. For example, processor 902 can also directly and very rapidly retrieve and store frequently needed data in a cache memory (not shown).

A removable mass storage device 912 provides additional data storage capacity for the computer system 900, and is coupled either bi-directionally (read/write) or unidirectionally (read only) to processor 902. For example, storage 912 can also include computer-readable media such as magnetic tape, flash memory, PC-CARDS, portable mass storage devices, holographic storage devices, and other storage devices. A fixed mass storage 920 can also, for example, provide additional data storage capacity. The most common example of mass storage 920 is a hard disk drive. Mass storages 912, 920 generally store additional programming instructions, data, and the like that typically are not in active use by the processor 902. It will be appreciated that the information retained within mass storages 912 and 920 can be incorporated, if needed, in standard fashion as part of memory 910 (e.g., RAM) as virtual memory.

In addition to providing processor 902 access to storage subsystems, bus 914 can also be used to provide access to other subsystems and devices. As shown, these can include a display monitor 918, a network interface 916, a keyboard 904, and a pointing device 906, as well as an auxiliary input/output device interface, a sound card, speakers, and other subsystems as needed. For example, the pointing device 906 can be a mouse, stylus, track ball, or tablet, and is useful for interacting with a graphical user interface.

The network interface 916 allows processor 902 to be coupled to another computer, computer network, or telecommunications network using a network connection as shown. For example, through the network interface 916, the processor 902 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 902 can be used to connect the computer system 900 to an external network and transfer data according to standard protocols. For example, various process embodiments disclosed herein can be executed on processor 902, or can be performed across a network such as the Internet, intranet networks, or local area networks, in conjunction with a remote processor that shares a portion of the processing. Additional mass storage devices (not shown) can also be connected to processor 902 through network interface 916.

An auxiliary I/O device interface (not shown) can be used in conjunction with computer system 900. The auxiliary I/O device interface can include general and customized interfaces that allow the processor 902 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 9 is but an example of a computer system suitable for use with the various embodiments disclosed herein. Other computer systems suitable for such use can include additional or fewer subsystems. In addition, bus 914 is illustrative of any interconnection scheme serving to link the subsystems. Other computer architectures having different configurations of subsystems can also be utilized.

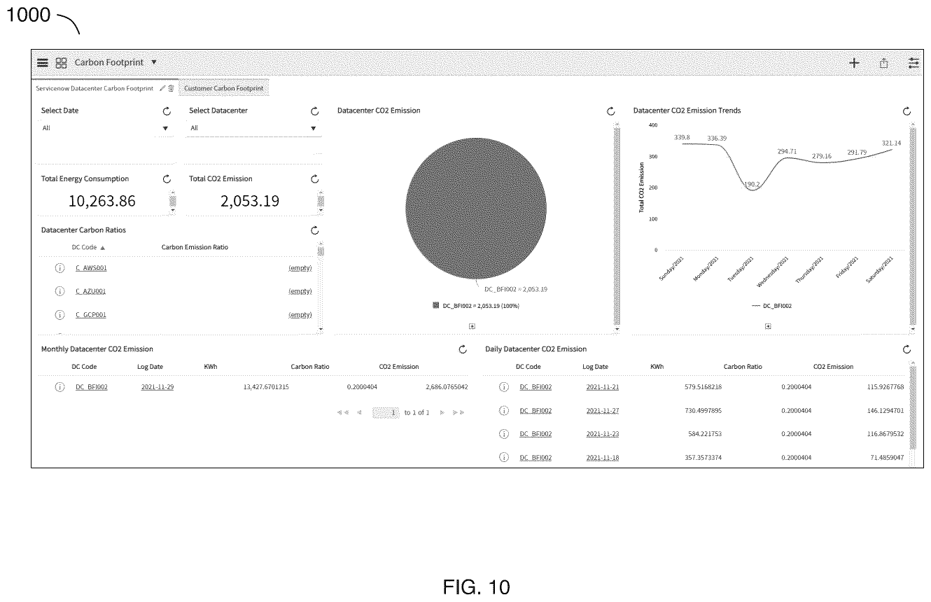

FIG. 10 is a diagram illustrating an embodiment of a user interface for viewing emissions metrics for a data center via an emissions dashboard. In the example shown, user interface 1000 is a user interface view of a user interface emissions dashboard for viewing data center emissions metrics including total energy consumption and total CO2 emissions. As shown in FIG. 10, the emissions metrics are provided for particular data centers with no restrictions on the entities utilizing the data centers. Additional daily metrics are provided as well as a daily trend view of CO2 emissions. In various embodiments, the dashboard of user interface 1000 is interactive and different user interface views can be selected to provide additional emissions metrics. In various embodiments, user interface 1000 is provided to a client such as client 101 of FIG. 1 by a carbon footprint application service such as carbon footprint app service 103 of FIG. 1 and/or carbon footprint app service 301 of FIG. 3. In some embodiments, the metrics provided in user interface 1000 correspond to a data center such as data center 111, 113, and/or 115 of FIG. 1 and/or data center 311 and/or 313 of FIG. 3.

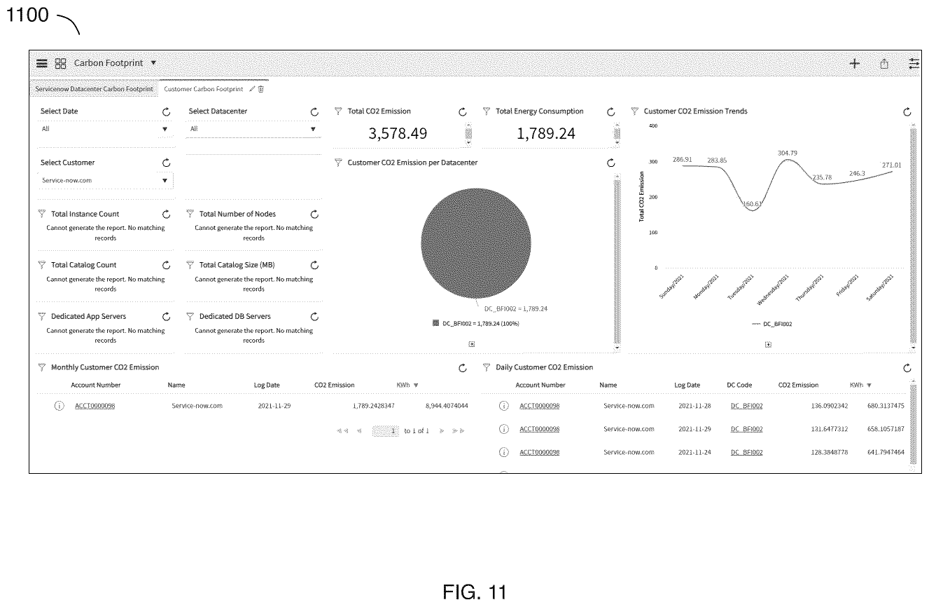

FIG. 11 is a diagram illustrating an embodiment of a user interface for viewing emissions metrics for an entity via an emissions dashboard. In the example shown, user interface 1100 is a user interface view of a user interface emissions dashboard for viewing an entity's emissions metrics including total energy consumption and total CO2 emissions. As shown in FIG. 11, the emissions metrics are provided for a particular entity (or customer) and for selected data center(s) associated with the entity. In the example shown, the selected entity is customer “Service-now.com.” Additional entity daily metrics are provided as well as a daily trend view of entity CO2 emissions. In various embodiments, the dashboard of user interface 1100 is interactive and different user interface views can be selected to provide additional emissions metrics for the selected entity and/or for selecting another entity. In various embodiments, user interface 1100 is provided to a client such as client 101 of FIG. 1 by a carbon footprint application service such as carbon footprint app service 103 of FIG. 1 and/or carbon footprint app service 301 of FIG. 3. In some embodiments, the metrics provided in user interface 1100 correspond to a data center such as data center 111, 113, and/or 115 of FIG. 1 and/or data center 311 and/or 313 of FIG. 3.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
receiving energy usage data of devices;
determining relative utilization values associated with the devices for an entity;
calculating a carbon footprint of the entity based on the energy usage data, the relative utilization values, and one or more emissions impact factors associated with one or more energy sources of the devices; and
providing an interactive user interface dashboard providing information regarding the carbon footprint.

2. The method of claim 1, wherein the one or more emissions impact factors are determined based on respective physical locations of the devices.

3. The method of claim 1, wherein the devices are physically located across two or more data center locations.

4. The method of claim 1, wherein the entity corresponds to a user account.

5. The method of claim 1, wherein the entity corresponds to a cloud service provider.

6. The method of claim 1, wherein the information regarding the carbon footprint includes daily, weekly, and monthly information corresponding to the carbon footprint of the entity.

7. The method of claim 1, wherein the information regarding the carbon footprint includes quantities of the carbon footprint of the entity for different physical locations.

8. The method of claim 7, wherein the different physical locations correspond to different data center locations.

9. The method of claim 7, wherein the information regarding the carbon footprint further includes quantities of the carbon footprint of the entity for different devices.

10. The method of claim 1, wherein the determined relative utilization values associated with the devices for the entity are based on processor activity associated with the entity.

11. The method of claim 1, wherein the received energy usage data of the devices is gathered from one or more power monitoring devices.

12. The method of claim 11, wherein each of the one or more power monitoring devices is associated with at least one rack installed in a data center.

13. The method of claim 11, wherein at least one of the devices is installed in a rack of a data center equipped with at least one of the one or more power monitoring devices.

14. A system, comprising:
one or more processors; and
a memory coupled to the one or more processors, wherein the memory is configured to provide the one or more processors with instructions which when executed cause the one or more processors to:
receive energy usage data of devices;
determine relative utilization values associated with the devices for an entity;
calculate a carbon footprint of the entity based on the energy usage data, the relative utilization values, and one or more emissions impact factors associated with one or more energy sources of the devices; and
provide an interactive user interface dashboard providing information regarding the carbon footprint.

15. The system of claim 14, wherein the one or more emissions impact factors are determined based on respective physical locations of the devices.

16. The system of claim 14, wherein the devices are physically located across two or more data center locations.

17. The system of claim 14, wherein the information regarding the carbon footprint includes quantities of the carbon footprint of the entity for different physical locations.

18. The system of claim 14, wherein the determined relative utilization values associated with the devices for the entity are based on processor activity associated with the entity.

19. The system of claim 14, wherein the received energy usage data of the devices is gathered from one or more power monitoring devices.

20. A computer program product, the computer program product being embodied in a non-transitory computer readable storage medium and comprising computer instructions for:
receiving energy usage data of devices;
determining relative utilization values associated with the devices for an entity;
calculating a carbon footprint of the entity based on the energy usage data, the relative utilization values, and one or more emissions impact factors associated with one or more energy sources of the devices; and
providing an interactive user interface dashboard providing information regarding the carbon footprint.
